(19) United States
(12) Patent Application Publication
(10) Pub. No.: US 2010/0050504 A1
(43) Pub. Date: Mar. 4, 2010

(54) NORMAL AND ISO PARAFINES WITH LOW CONTENT OF AROMATICS, SULPHUR AND NITROGEN AS COLLECTOR FOR FROTH FLOTATION

(76) Inventors: Jörg Landschof, Hamburg (DE); Karsten Wilbrand, Hamburg (DE)

Correspondence Address: SHELL OIL COMPANY, P O BOX 2463, HOUSTON, TX, 772522463, US

(21) Appl. No.: 12/517,714

(22) PCT Filed: Dec. 6, 2007
(86) PCT No.: PCT/EP07/63430

§ 371 Date: Jun. 23, 2009

(30) Foreign Application Priority Data
Dec. 6, 2006 (EP) 06125536.0

(51) Int. Cl. B03D 1/001; C10L 5/00

(52) U.S. Cl. 44/621; 252/61

(57) ABSTRACT

The present invention relates to a flotation agent comprising a collector hydrocarbon composition comprising more than 80 wt % of iso and normal paraffins, less than 1 wt % aromatics, less than 5 ppm sulphur and less than 1 ppm nitrogen, and having a density of between 0.65 and 0.8 g/cm3 at 15° C., and at least one frothing agent, and to a process for the froth flotation of non-metal and metal ores and sludges.

### FIELD OF INVENTION

The present invention relates to a flotation agent comprising a collector hydrocarbon composition for the froth flotation of ores, and more particularly to the use of a paraffinic collector hydrocarbon composition for recovery of coal from coal ores and coal sludges.

### BACKGROUND OF THE INVENTION

Froth flotation processes are generally employed in the mining industry for the separation of a large range of metal ores, such sulphides, carbonates, phosphates and oxides of metals of groups 3 to 12 of the periodic table of elements and/or coal and sulphur as well as non-metal ores, such as coal or sulphur. Accordingly, the use of highly biodegradable, yet hydrolytically stable flotation agents or fluids would be desirable in particular in view of spills. A further problem is the presence of aromatics, such as alkylbenzenes (eg mono-, di- and polyalkylbenzenes), but even more specifically polynuclear aromatics and/or sulphur results in emissions of soot and sulphurous oxides when combusted, such as those disclosed in WO-A-2006/086443. Moreover, such fluids tend to show only a limited aquatic biodegradability. Hence, the use of flotation agents that are lower in sulphur—and/or aromatics content than those disclosed in WO-A-2006/086443 would be equally desirable since these can be incinerated.

Coal, a combustible carbonaceous solid material, is found in deposits that inherently contain non-combustible mineral matter. Although large fragments of the non-combustible materials can be removed by screening or conventional gravity concentration techniques such as centrifugation, froth flotation is a commonly employed selective process for separating remove finer non-combustible materials from coal, also referred to as the “beneficiation” of coal. This selective separation of the minerals makes processing complex coal ores and in particular coal sludges with low coal content economically feasible. “Selectivity” refers to minimizing the amounts of undesirable non-combustible material or ash in the froth. It is desirable to recover as much coal as possible in a selective manner, i.e. with an as high as possible yield, and as low as possible ash content. Furthermore, it would be desirable to be able to recover coal from coal deposits having very low coal content, such as for instance sludges that had previously been discarded due to a too low coal content.

Various flotation agents have been described for the frothing floatation, including mineral oil, wood or coal tar derived neutral hydrocarbon liquids, in combination with alcohols or other frothing agents. Typical mineral oil derived collector hydrocarbon compositions comprise liquid hydrocarbon middle distillate fuel oils having boiling points from about 150 to 400° C. In particular mineral oil, and natural or petroleum gas condensate derived gas oil and kerosene are the most widely hydrocarbon collector hydrocarbon compositions. A disadvantage of the use of mineral oil derived collector hydrocarbon compositions such as the gas oils disclosed in U.S. Pat. No. 4,416,769 and GB-A-2225260 is the low biodegradability and high marine toxicity of such fluids. This can be attributed to a number of components in these gas oil and kerosene type fluids, in particular the high amount of sulphur and nitrogen containing compounds, as well as the presence of aromatic and naphthenic hydrocarbons. Already a minute amount of the aromatic and naphthenic hydrocarbons is usually sufficient to reduce for instance the aquatic biodegradability to levels that no longer permit application in contact with ground or surface water. Alternative collector hydrocarbon compositions show limited hydrolytic stability, and therefore cannot be employed continuously, e.g. fatty acid esters such as rape seed methyl esters, as disclosed for instance in WO-A-2004/098782.

Accordingly, it would also be desirable to be able to recover coal from deposits of oxidized coal or deposits low in coal content in an economically and environmentally acceptable manner.

This has now been achieved by applicant in employing a highly iso-paraffinic flotation agent as follows.

### SUMMARY OF THE INVENTION

Accordingly, the present invention relates to a flotation agent comprising a collector hydrocarbon composition comprising more than 80 wt % of iso and normal paraffins, less than 5 ppm sulphur and less than 1 ppm nitrogen, and having a density of between 0.65 and 0.8 g/cm³ at 15° C., and at least one frothing agent.

### DETAILED DESCRIPTION OF THE INVENTION

In general, a flotation process (also referred to as “froth flotation” process) for the beneficiation of metal or no metal ores, such as coal ores is performed by finely disseminating air bubbles through an aqueous fine slurry of the ground metal or non-metal ore, or sludge. Hydrophobic particles, such as coal particles or metal ore particles that are made hydrophobic by treatment with a flotation agent comprising a collector composition, adhere to the air bubbles, and float to the surface of the aqueous slurry where they are removed as a concentrated froth.

Froth flotation thus commences by comminution, which is used to increase the surface area of the ore for subsequent processing and break the rocks into the desired mineral and gangue (which then has to be separated from the desired mineral); the ore is ground into a fine powder.

The slurry (also referred to as pulp) of hydrophobic mineral-bearing ore and in the case of coal floatation, hydrophilic coal is then introduced to an aerated bath in which bubbles are created.

The hydrophobic grains of mineral or coal-bearing ore escape the water by attaching to the air bubbles which rises to the surface, forming a froth on the surface of the bath vessel. In the case of coal refining, the froth contains the coal fines, which are then removed from the separated off mineral for further refining.

Non-adhering particles (tailings) or waste remain suspended in the slurry, or fall to the lower levels of the slurry.

In this process, usually flotation agents are employed. These generally comprise a collector and a frothing agent. The collector attracts the hydrophobic particles, while the frothing agent, such as for instance a long chain alkyl alcohol, is present to create a stable froth layer in the cell. The basic purpose of a collector is thus to render the desired particles hydrophobic, thereby decreasing contact angles and surface viscosity, and increasing wetability and adhesion between these particles and the rising air bubbles. At the same time, the collector composition should be selective in that the tailings or waste are not rendered hydrophobic and thus do not float.

Flotation can be performed in mechanically agitated cells or tanks, in flotation columns and in several other units. Mechanical cells advantageously use a large mixer and diffuser mechanism at the bottom of the mixing tank to introduce air and provide mixing action. Flotation columns advantageously use air or gas spargers to introduce air at the bottom of a tall column while introducing slurry above. The counter-current motion of the slurry flowing down and the air flowing up provides mixing action. Mechanical cells generally have a higher throughput rate, but produce material that is of lower quality, while flotation columns generally have a low throughput rate but produce higher quality material.

The metal or metal ore or sludge may first be cleaned by gravity separation to reduce ash and pyrite content. These methods include jigging, tabling, and heavy-media separation. The ore fines of 400 mm diameter are usually treated by flotation.

Alternatively, the ore or sludge is preferably directly ground to a diameter of 600 mm or finer, and the whole mass subjected to flotation without recourse to primary gravity separation.

The sized ore or sludge flotation feed is, optionally, first washed and then mixed with sufficient water to prepare an aqueous slurry having a solids concentrate which promotes rapid flotation. Generally, a solids concentration of 2 to 20 weight percent solids, more preferably 5 to 12 weight percent, is employed.

The finely ground ore is advantageously conditioned, i.e. brought into intimate contact with the flotation agent comprising the collector hydrocarbon composition prior to addition of the water, e.g. by spraying. In instances where the aqueous coal slurry is prepared in a container distinct from the flotation cell and then is conveyed to the flotation through conduits, the desired intimate contact can conveniently be attained by introducing the flotation agent to the slurry upstream from the flotation cell.

A particularly advantageous embodiment of the present process is the process for coal beneficiation and use of the flotation agent according to the present invention in froth flotation for coal. Herein, the ground coal can be floated at the natural pH of the coal in the aqueous slurry, which will conventionally vary 3.0 to 9.5. However, the pH of the aqueous coal slurry is advantageously maintained, prior to and during flotation, at a value of 4 to 9, preferably 4 to 8, which generally promotes the greatest coal recovery. If the coal is acidic in character, the pH can be adjusted using an alkaline material such as soda ash, lime, ammonia, potassium hydroxide or magnesium hydroxide, with sodium hydroxide being preferred. If the aqueous coal slurry is alkaline in character, a carboxylic acid, such as acetic acid or the like, or a mineral acid, such as sulphuric acid, hydrochloric acid and the like, can be employed to adjust the pH.

The conditioned and pH-adjusted aqueous coal slurry is aerated in a flotation machine or bank of rougher cells to float the coal. Any suitable rougher flotation unit can be employed.

Many coals, particularly coals in which the surface has been at least partially oxidized (“weathered coal” such as sub-bituminous coal, or e.g. if the coal seam has been exposed to contact with air) have a lower hydrophobicity and thus are difficult to float. This results in an undesirable loss of significant amounts of combustible material in the tail or unfloated portion of the slurry. Similarly, coal could not easily be recovered from coal sludge, i.e. coal ore fines that had been discarded previously due to a low amount.

Applicants found that advantageously that the yield in coal could be increased if the flotation agent according to the invention comprising the collector hydrocarbon composition and an alcohol, preferably MIBC, are employed at a low pH-value, preferably in the range of from 0 to 3.

The process according to the subject invention can be used alone to beneficiate coal. Alternatively, the process can be used in conjunction with secondary flotation following the instant process to effect even greater beneficiation of the coal. Further increases in the amounts of this so-called “hard-to-float” coal recovered in the froth can be improved by increasing the concentration of collector hydrocarbon composition.

To avoid co-flotation of undesired mineral matter and thus to enhance coal recovery, further additives may preferably be added to the flotation agent, such as fatty acid amides, the condensation product of a fatty acid or fatty acid ester with the reaction product of a polyalkylenepolyamine and an alkylene oxide as described in U.S. Pat. No. 4,305,815; the condensation product of an alkanolamine and a fatty acid or fatty acid ester as described in U.S. Pat. No. 4,474,619 and the reaction product of the condensation product of diethanolamine and a fatty acid with a monocarboxylic acid as described in U.S. Pat. No. 4,330,339.

The process of the present invention can be employed to float anthracite, bituminous, sub-bituminous coal or the like. The process is preferably employed to float coal of intermediate or low rank where the surface of the coal is oxidized to an extent which significantly impedes the flotation of the coal using a conventional collector.

The flotation agent according to invention may comprise one or more hydrocarbon compositions, of which at least one is a paraffinic gas oil component as defined herein-above. With a paraffinic hydrocarbon composition is meant a composition comprising more than 80 wt % paraffins, more preferably more than 90 wt % paraffins and even more preferably more than 95 wt % paraffins.

The collector hydrocarbon composition will typically have a density from 0.75 to 0.8 g/cm³, preferably from 0.775 to 0.8 g/cm³, at 15° C. (e.g., ASTM D4502 or IP 365). The collector hydrocarbon composition typically has a density from and a cetane number (as measured by either ASTM D613 or IP 498[IQT]) of from 35 to 95, more preferably from 60 to 85.

It will typically have an initial boiling point in the range 150 to 230° C. and a final boiling point in the range 290 to 400° C. Its kinematic viscosity at 40° C. (ASTM D445) might suitably be from 1.5 to 4.5 centistokes, preferably from 2 to 4.5, more preferably from 2.5 to 4.0, yet more preferably from 2.9 to 3.7, centistokes at 40° C. Its sulphur content (determined according to ASTM D2622) is less than 5 ppmw or less, preferably 2 ppmw or less. Its nitrogen content (determined according to ASTM D 4629) is less than 1 ppmw or less, preferably 0.5 ppmw or less.

The components of collector hydrocarbon composition preferably have boiling points within the typical gas oil and/or kerosene range, i.e., from about 150 to 400° C. or from 170 to 370° C. They will suitably have a 90 % w/w distillation temperature of from 300 to 370° C.

The collector hydrocarbon composition preferably comprises a gas oil fraction, a kerosene fraction, or a blend of both. These preferably are liquid hydrocarbon middle distillate fractions with a distillation range suitably from about 150 to 250° C. or from about 150 to 210° C.

A gas oil fraction preferably has a density from 760 to 790 kg/m³ at 15° C.; a cetane number (DIN 51773) greater than 70, suitably from 74 to 85; a kinematic viscosity from 2.0 to 4.5, preferably from 2.5 to 4.0, more preferably from 2.9 to 3.7, cSt (mm²/s) at 40° C.; and a sulphur content of 5 ppmw (parts per million by weight) or less, preferably of 2 ppmw or less. A kerosene fraction preferably has a final boiling point of typically from 190 to 260° C., for instance from 190 to 210° C. for a typical “narrow-cut” kerosene fraction or from 240 to 260° C. for a typical “full-cut” fraction. Its initial boiling point is preferably from 140 to 160° C. The kerosene fraction preferably has a density of from 0.730 to 0.760 g/cm³ at 15° C.—for instance from 0.730 to 0.745 g/cm³ for a narrow-cut fraction and from 0.735 to 0.760 g/cm³ for a full-cut fraction; and a sulphur content of 5 ppmw (parts per million by weight) or less, preferably of 2 ppmw or less.

It further preferably has a cetane number of from 63 to 75, for example from 65 to 69 for a narrow-cut fraction, and from 68 to 73 for a full cut fraction. The kerosene useful in the collector hydrocarbon composition preferably is the product of a SMDS process, preferred features of which may be as described below. It preferably has a sulphur content of 5 ppmw (parts per million by weight) or less.

The collector hydrocarbon composition may advantageously comprise a one or more Fischer-Tropsch derived gas oil and/or kerosene fractions, optionally in admixture with non-Fischer-Tropsch derived gas oil and/or kerosene.

The collector hydrocarbon composition may also comprise a paraffinic gas oil derived by a catalytic method for the manufacture of hydrocarbons, which are suitable for diesel fuel pool, from renewable sources, such as plant and vegetable oils and fats and animal and fish oils and fats, as disclosed for instance in EP-A-1681337.

Applicants found that a collector hydrocarbon composition according to the invention is qualified as readily biodegradable according to ISO 14593.

The iso to normal ratio of the paraffins as present in the collector hydrocarbon composition is preferably is greater than 0.3, more preferably greater than 1, even more preferably greater than 3. The collector hydrocarbon composition may comprise substantially only iso-paraffins.

The collector hydrocarbon composition preferably comprises a series of iso-paraffins having n, n+1, n+2, n+3 and n+4 carbon atoms, and wherein n is between 8 and 25, more preferably between 8 and 20, and most preferably between 8 and 18. Such collector hydrocarbon composition is also known as a paraffinic gas oil or kerosene, i.e. a product fraction boiling in the gas oil and/or kerosene range, or a blend thereof obtained from a Fischer-Tropsch synthesis process.

By “Fischer-Tropsch derived” is meant that a hydrocarbon composition is, or derives from, a synthesis product of a Fischer-Tropsch condensation process. The term “non-Fischer-Tropsch derived” may be interpreted accordingly.

The Fischer-Tropsch reaction converts carbon monoxide and hydrogen into longer chain, usually paraffinic, hydrocarbons:

n(CO+2H₂)=(—CH₂—)ₙ+nH₂O+heat,

in the presence of an appropriate catalyst and typically at elevated temperatures (e.g., 125 to 300° C., preferably 175 to 250° C.) and/or pressures (e.g., 5 to 100 bar, preferably 12 to 50 bar). Hydrogen:carbon monoxide ratios other than 2:1 may be employed if desired. The carbon monoxide and hydrogen may themselves be derived from organic or inorganic, natural or synthetic sources, typically either from natural gas or from organically derived methane.

The collector hydrocarbon composition containing a continuous iso-paraffinic series as described above may preferably be obtained by hydroisomerisation of a paraffinic wax, preferably followed by some type of dewaxing, such as solvent or catalytic dewaxing. The paraffinic wax is preferably a Fischer-Tropsch derived wax.

Gas oil and kerosene products may be obtained directly from the Fischer-Tropsch reaction, or indirectly for instance by fractionation of Fischer-Tropsch synthesis products or preferably from hydrotreated Fischer-Tropsch synthesis products.

Hydrotreatment preferably involves hydrocracking to adjust the boiling range (see, e.g., GB-B-2077289 and EP-A-0147873) and/or hydroisomerisation, which can improve cold flow properties by increasing the proportion of branched paraffins. EP-A-0583836 describes a two step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel. The desired gas oil fraction(s) may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for instance in US Pat. No. 4,125,566 and U.S. Pat. No. 4,478,955.

Examples of Fischer-Tropsch processes which for example can be used to prepare the above-described Fischer-Tropsch derived collector hydrocarbon composition are the so-called commercial Slurry Phase Distillate technology of Sasol, the Shell Middle Distillate Synthesis Process and the “AGC-21” Exxon Mobil process. These and other processes are for example described in more detail in EP-A-776959, EP-A-668342, U.S. Pat. No. 4,943,672, U.S. Pat. No. 5,059,299, WO-A-9934917 and WO-A-9920720.

The SMDS (Shell Middle Distillate Synthesis) is described in detail in “The Shell Middle Distillate Synthesis Process”, van der Burgt et al (supra). This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as the gas oils useable in diesel fuel compositions. A version of the SMDS process, utilizing a fixed bed reactor for the catalytic conversion step, is currently in use in Bintulu, Malaysia.

Gas oil and kerosene fractions prepared by the SMDS process are commercially available for instance from Shell companies under the Sarasol tradenames. Further examples of Fischer-Tropsch derived gas oils are described in EP-A-0583836, EP-A-1101813, WO-A-97/14768, WO-A-97/14769, WO-A-00/20534, WO-A-00/20535, WO-A-00/11116, WO-A-00/11117, WO-A-01/83406, WO-A-01/83641, WO-A-01/83647, WO-A-01/83648 and U.S. Pat. No. 6,204,426.

In the case of the Fischer-Tropsch derived collector hydrocarbon composition, the collector hydrocarbon composition contains a continuous series of the series of iso-paraffins having n, n+1, n+2, n+3 and n+4 carbon atoms.

The content and the presence of the a continuous series of the series of iso-paraffins having n, n+1, n+2, n+3 and n+4 carbon atoms in the collector hydrocarbon composition or base stock (i) may be measured by Field desorption/Field Ionisation (FD/FI) technique. In this technique the oil sample is first separated into a polar (aromatic) phase and a non-polar (saturates) phase by making use of a high performance liquid chromatography (HPLC) method IP368/01, wherein as mobile phase pentane is used instead of hexane as the method states. The saturates and aromatic fractions are then analyzed using a Finnigan MAT90 mass spectrometer equipped with a Field desorption/Field Ionisation (FD/FI) interface, wherein FI (a “soft” ionisation technique) is used for the determination of hydrocarbon types in terms of carbon number and hydrogen deficiency. The type classification of compounds in mass spectrometry is determined by the characteristic ions formed and is normally classified by “z number”. This is given by the general formula for all hydrocarbon species: CₙH_{2n+z}. Because the saturates phase is analysed separately from the aromatic phase, it is possible to determine the content of the different iso-paraffins having the same stoichiometry or n-number. The results of the mass spectrometer are processed using commercial software (poly 32; available from Sierra Analytics LLC, 3453 Dragoo Park Drive, Modesto, Calif. GA95350 USA) to determine the relative proportions of each hydrocarbon type.

The collector hydrocarbon composition preferably has essentially no, or undetectable levels of, sulphur and nitrogen. Further, the collector hydrocarbon composition preferably comprises no or virtually no aromatic components.

The aromatics content of the collector hydrocarbon composition, suitably determined by ASTM D4629, will be below 1 wt. % (w/w), preferably below 0.5 wt. % and more preferably below 0.1 wt. %.

In the flotation agent, the amount of collector hydrocarbon composition preferably is in the range of from 50-250 grams per ton of coal ore, calculated on a dry weight basis. Yet more preferably, the collector hydrocarbon composition is essentially free from aromatic compounds.

The flotation agent according to the present invention comprises a frothing agent.

This frothing agent is preferably selected from the group of alcohols, fatty acids, fatty acid alkyl esters, the condensation products of an alkanolamine and a fatty acid or fatty acid ester, the condensation products of a fatty acid with a polyalkylenepolyamine and an alkylene oxide, the condensation product of diethanolamine and a fatty acid with a monocarboxylic acid, or mixtures thereof.

Alcohols suitable as frothing agents include hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or commercially available C₁₂₋₁₄ alcohol mixtures. Yet more preferably, the alcohol is 4-methyl-2-pentanol (also known as methyl isobutyl carbinol, or MIBC), amyl alcohol (1-pentanol and its regioisomers 3-methyl-1-butanol, 2-methyl-1-butanol, 2,2-dimethyl-1-propanol, 2-pentanol, 3-pentanol, 3-methyl-2-butanol, 2-methyl-2-butanol), hexanol, heptanol, octanol.

Other preferred frothing agents include terpenic alcohols such as those present in pine oil, polyglycols, polyoxyparafins and/or cresylic acid. More preferably, the frothing agent is an alcohol, yet more preferably 4-methyl-2-pentanol. The amount of frothing agent in the flotation agent preferably is in the range of from 250-1000 grams per ton of coal ore, calculated on a dry weight basis.

The ratio of collector hydrocarbon composition to frothing agent can be any ratio suitable for the application. Preferably, the weight ratio of collector hydrocarbon composition to frothing agent is in the range of from 10:90 to 90:10, more preferably in the range of from 20:80 to 80:20, and most preferably in the range of from 25:75 to 35:65.

The present invention further relates to a froth flotation process for the beneficiation of sulphides, carbonates, phosphates and oxides of metals of groups 3 to 12 of the periodic table of elements as defined in the CRC Handbook of Chemistry and Physics, Chapter 1-11, 71^{st} edition 1991, CRC Press, and/or coal and sulphur ores and sludges, comprising flotating the ore or sludge comprising the desired metal compound or non-metal compound in a frothing aqueous medium containing an effective amount of a paraffinic hydrocarbon blend as a collector hydrocarbon composition comprising more than 80 wt % of iso and normal paraffins, less than 1 wt % aromatics, less than 5 ppm sulphur and less than 1 ppm nitrogen, and having a density of between 0.65 and 0.8 g/cm³ at 15° C.

The collector hydrocarbon composition preferably comprises less than 1 wt % oxygenates.

This process further preferably comprises flotating an ore or sludge in a frothing aqueous medium containing an effective amount of the paraffinic hydrocarbon blend as a collector hydrocarbon composition. The process further preferably comprises the steps of (a) contacting the ore or sludge with the collector hydrocarbon composition and a frothing agent, and (b) forming an aqueous slurry of the product of step (a), and (c) subjecting the aqueous slurry of the fine coal containing the collector hydrocarbon composition and frothing agent to a froth flotation manipulation, and (d) separating the tailing of the froth flotation manipulation from the floated material. In the case of coal beneficiation, the floated material consists essentially of the beneficiated fine coal.

Step (a) preferably comprises: (i) grinding the ore to liberate the mineral particles; and (ii) adding the ground ore to an aqueous medium comprising the collecting fluid.

Step (c) preferably comprises (iii) contacting the product of step (a) with air or nitrogen such that a mineral laden froth is formed on the surface of a flotation cell; and (iv) separating a froth laden with the hydrophilic components formed in step (c) from the surface of the flotation cell, and optionally, (v) collecting the components retained in the slurry. The ore or sludge preferably is a coal ore or coal sludge, wherein the coal is separated off from the surface.

The present invention further relates to the use of a gas oil or kerosene comprising more than 80 wt % of iso and normal paraffins, less than 1 wt % aromatics, less than 5 ppm sulphur and less than 1 ppm nitrogen, and having a density of between 0.65 and 0.8 g/cm³ at 15° C. in a collector hydrocarbon composition according to claims 1 to 8 for the improved froth flotation recovery of sulphides, carbonates, phosphates and oxides of metals of groups 3 to 12 of the periodic table of elements and/or coal and sulphur. Preferably, the gas oil or kerosene is a Fischer-Tropsch derived hydrocarbon composition.

In a preferred embodiment, the present process preferably relates to a froth flotation process for the beneficiation of fine coal, comprising flotating a coal ore in a frothing aqueous medium containing an effective amount of a paraffinic hydrocarbon blend as a collector hydrocarbon composition and a frothing agent as defined herein-above. Preferably, this process comprises (a) forming an aqueous slurry of the fine coal containing a collector and a frothing agent, and (b) subjecting the aqueous slurry of the fine coal containing the collector hydrocarbon composition and frothing agent to a froth flotation manipulation, and (c) separating the tailing of the froth flotation manipulation from the floated material consisting essentially of the beneficiated fine coal. Step (a) preferably comprises: (i) grinding the coal ore to liberate the mineral particles; (ii) adding the ground coal ore to an aqueous medium comprising the collecting fluid. Step (b) preferably comprises (iii) contacting the product of step (a) with air or nitrogen such that a mineral laden froth is formed on the surface of a flotation cell; and (iv) separating a coal laden froth formed in step (c) from the surface of the flotation cell.

1. A flotation agent comprising a collector hydrocarbon composition comprising more than 80 wt % of iso and normal paraffins, less than 1 wt % aromatics, less than 5 ppm sulphur and less than 1 ppm nitrogen, and having a density of between 0.65 and 0.8 g/cm³ at 15° C., and at least one frothing agent.

2. A flotation agent according to claim 1, wherein the collector hydrocarbon composition comprises less than 1 wt % oxygenates.

3. A flotation agent according to claim 1, wherein the collector hydrocarbon composition comprises a series of iso-paraffins having n, n+1, n+2, n+3 and n+4 carbon atoms, wherein n is between 8 and 25.

4. A flotation agent according to claim 1, wherein the frothing agent is selected from the group consisting of alcohols, fatty acids, fatty acid alkyl esters, the condensation products of an alkanolamine and a fatty acid or fatty acid ester, the condensation products of a fatty acid with a polyalkylenepolyamine and an alkylene oxide, the condensation product of diethanolamine and a fatty acid with a monocarboxylic acid, and mixtures thereof.

5. A flotation agent according to claim 4, wherein the frothing agent is methyl iso butyl carbinol, and wherein the weight ratio of the collector hydrocarbon composition to the frothing agent is in the range of from 25:75 to 75:25.

6. A method of recovery coal from a mixture of coal and non-combustible materials comprising subjecting the mixture to a froth flotation process using a flotation agent according to claim 1, wherein the amount of the paraffinic hydrocarbon composition in the collector hydrocarbon composition is in the range of from 50-250 grams per ton of coal ore, calculated on a dry weight basis.

7. A method of recovery coal according to claim 6 wherein the frothing agent comprises an alcohol and the amount of alcohol in the collector hydrocarbon composition is in the range of from 250-1000 grams per ton of coal ore, calculated on a dry weight basis.

8. A flotation agent according to claim 1, wherein the collector hydrocarbon composition is free from aromatic compounds.

9. A flotation agent according to claim 1, wherein the flotation agent comprises a hydrocarbon blend having a cetane number of greater than 60, a kinematic viscosity at 40° C. of greater than 3.0 cSt and a density at 15° C. of greater than 830 kg/m³.

10. A froth flotation process for the beneficiation of sulphides, carbonates, phosphates and oxides of metals of groups 3 to 12 of the periodic table of elements and/or coal and sulphur ores and sludges, comprising flotating the ore or sludge comprising the desired metal compound or non-metal compound in a frothing aqueous medium containing an effective amount of a paraffinic hydrocarbon blend as a collector hydrocarbon composition comprising more than 80 wt % of iso and normal paraffins, less than 1 wt % aromatics, less than 5 ppm sulphur and less than 1 ppm nitrogen, and having a density of between 0.65 and 0.8 g/cm³ at 15° C.

11. A process according to claim 10, which process comprises
(a) contacting the ore or sludge with the collector hydrocarbon composition and a frothing agent, and
(b) forming an aqueous slurry of the product of step (a), and
(c) subjecting the aqueous slurry of the ore containing the collector hydrocarbon composition and frothing agent to a froth flotation manipulation, and
(d) separating the tailing of the froth flotation manipulation from the floated material.

12. A process according to claim 11, wherein step (a) comprises:
(i) grinding the ore to liberate the mineral particles;
(ii) adding the ground ore to an aqueous medium comprising the collecting fluid.

13. A process according to claim 11, wherein step (c) comprises
(iii) contacting the product of step (a) with air or nitrogen such that a mineral laden froth is formed on the surface of a flotation cell; and
(iv) separating a froth laden with the hydrophilic components formed in step (c) from the surface of the flotation cell, and optionally,
(v) collecting the components retained in the slurry

14. A process according to claim 10, wherein the ore or sludge is a coal ore or coal sludge.

15. (canceled)
